(19) United States
(12) Patent Application Publication
(10) Pub. No.: US 2007/0156496 A1
(43) Pub. Date: Jul. 5, 2007

(54) METHODS AND SYSTEMS FOR MANAGING AIRCRAFT MAINTENANCE AND MATERIAL SUPPLY

(76) Inventors: Robert L. Avery, Woodinville, WA (US); David R. Leonhardi, Shoreline, WA (US); Wendy A. Cronie, Issaquah, WA (US); Margaret L. Nomi, Issaquah, WA (US); Patricia L. Rhodes, Lake Stevens, WA (US); Jay P. Maloney, Federal Way, WA (US); Matthew C. Bueser, Mill Creek, WA (US); Grant H. Thacker, Park City, UT (US); Erik Fromm, Bellevue, WA (US); Cheryl Khera, Bellevue, WA (US); Paula M. Kirkish, Renton, WA (US)

Correspondence Address: John S. Beulick;Armstrong Teasdale LLP, Suite 2600, One Metropolitan Square, St. Louis, MO, 63102, US

(21) Appl. No.: 11/563,523

(22) Filed: Nov. 27, 2006

Related U.S. Application Data
(60) Provisional application No. 60/741,709, filed on Dec. 2, 2005.

(51) Int. Cl. G06F 9/46

(52) U.S. Cl. 705/8

(57) ABSTRACT

Methods and systems for managing aircraft maintenance and material supply by a business entity for at least one customer are provided. The method includes managing a plurality of maintenance activities for an aircraft by the business entity wherein the plurality of maintenance activities are performed by at least one maintenance entity separate from the business entity and the at least one customer. The method further includes managing a supply of aircraft parts to the maintenance entity from a plurality of parts suppliers by the business entity and outputting at least one maintenance activity to be performed by the maintenance entity.

### CROSS REFERENCE TO RELATED APPLICATIONS

This application claims priority to U.S. Provisional Patent Application Ser. No. 60/741,709 filed Dec. 2, 2005 the contents of which are hereby incorporated by reference.

### BACKGROUND OF THE INVENTION

This invention relates generally to airline operations and more particularly, to methods and systems for managing a maintenance and material supply service for aircraft.

Owners of fleets of vehicles generally desire to minimize the cost of maintaining such vehicles. Airlines operate fleets of aircraft whose parts deteriorate over time. The aircraft also include components that are checked periodically for conformance to standards and/or per regulatory directives that require certain maintenance on the aircraft to maintain an airworthiness certification. Each airline may operate different models of aircraft manufactured by one manufacturer or may operate models manufactured by different manufacturers. Maintaining maintenance requirements, operating parameters and part specifications for a multitude of different aircraft and all their component parts may become an unwieldy task that some airline may prefer to outsource to specialized providers. However, managing a plurality of maintenance providers, parts suppliers, and other entities that typically supply services to airlines may also become unwieldy.

### BRIEF DESCRIPTION OF THE INVENTION

In one embodiment, a method of managing aircraft maintenance and material supply by a business entity for at least one customer includes managing a plurality of maintenance activities for an aircraft by the business entity wherein the plurality of maintenance activities are performed by at least one maintenance entity separate from the business entity and the at least one customer. The method further includes managing a supply of aircraft parts to the maintenance entity from a plurality of parts suppliers by the business entity and outputting at least one maintenance activity to be performed by the maintenance entity.

In another embodiment, a network-based system for managing aircraft maintenance and material supply by a business entity for at least one customer includes a database that includes data relating to aircraft maintenance, the data relating to at least one of maintenance instructions for a plurality of different types of aircraft, regulatory directives, and a plurality of aircraft parts, components, and hardware. The system also includes a first computer system configured to be coupled to the database and the first computer system is further configured to store data in the database, manage a plurality of maintenance activities for an aircraft by the business entity, the plurality of maintenance activities performed by at least one maintenance entity separate from the business entity and the at least one customer, the aircraft being operated by the at least one customer. The first computer system is further configured to manage a supply of aircraft parts to the maintenance entity from a plurality of parts suppliers by the business entity.

In yet another embodiment, a network-based system for managing aircraft maintenance and material supply by a business entity for at least one customer includes a database that includes data relating to aircraft maintenance, the data relating to at least one of maintenance instructions for a plurality of different types of aircraft, regulatory directives, and a plurality of aircraft parts, components, and hardware. The system further includes a first computer system configured to be coupled to the database, a second computer system communicatively coupled to the first computer system, the second computer system configured to receive maintenance reports from the maintenance entity and transmit at least a portion of the maintenance reports to the first computer system and a third computer system communicatively coupled to the first and second computer systems, the third computer system configured to communicate parts information between the first and second computer systems. The first computer system is further configured to store data in the database, manage a plurality of maintenance activities for an aircraft by the business entity, the plurality of maintenance activities performed by at least one maintenance entity separate from the business entity and the at least one customer, the aircraft being operated by the at least one customer, and manage a supply of aircraft parts to the maintenance entity from a plurality of parts suppliers by the business entity.

### BRIEF DESCRIPTION OF THE DRAWINGS

FIG. 1 is a simplified block diagram of an Integrated Maintenance and Material Supply System (IMMSS) in accordance with an embodiment of the present invention;

FIG. 2 is an expanded version block diagram of an exemplary embodiment of a server architecture of IMMSS;

FIG. 3 is an information flow diagram of an exemplary embodiment of the Integrated Maintenance and Material Supply System (IMMSS) shown in FIG. 2; and

FIG. 4 is a flow diagram of a method for managing aircraft maintenance and material supply by a business entity for at least one customer in accordance with an exemplary embodiment of the present invention.

### DETAILED DESCRIPTION OF THE INVENTION

The following descriptions of various embodiments are merely exemplary in nature and is in no way intended to limit the invention, its application, or uses. Additionally, the advantages provided by the preferred embodiments, as described below, are exemplary in nature and not all preferred embodiments provide the same advantages or the same degree of advantages.

Exemplary embodiments of systems and processes that facilitate integrated network-based maintenance and material supply process management related to an integrated maintenance and material service system (IMMSS) are described below in detail. A technical effect of the systems and processes described herein include at least one of facilitating an electronic submission of information using a client system, automating extraction of information, and web-based or internal network based reporting for internal and external system users. The IMMSS allows a business engaging in complex transactions, such as aircraft maintenance, servicing, parts and other material supplies, to collect, manage, store and disseminate aircraft maintenance and parts information among internal and separate external entities to facilitate a more accurate and efficient analysis of the costs associated with aircraft maintenance and parts supply and to facilitate management of workload and personnel. The IMMSS also allows a business engaging in complex transactions to manage customer relationships, manage specific regulatory information, manage and create an electronic aircraft fleet history file, manage and create an electronic account manager journal, train personnel, and provide predictive measures based on history, industry trends and economic data.

The IMMSS also allows a business engaging in complex transactions to generate a plurality of aircraft maintenance and parts scenarios for a customer involved in a transaction, and then compare financial scenarios associated with the transactions for establishing costs of providing maintenance and parts supply services. For example, a business entity may project an expected financial scenario for a customer at the time of contracting for maintenance and parts supply integration services. After implementing the contract, the business entity may then utilize the IMMSS to compare actual financial numbers for the customer and itself at any point in the future to the expected financial scenario. By making this comparison, the business entity can calculate a variance between the expected scenario and actual. The business entity can also evaluate and revise its contracting processes based on such comparisons.

In addition, the IMMSS allows a business entity to monitor each customer account and each aircraft in each fleet of aircraft. In the exemplary embodiment, the IMMSS collects, tracks, displays, and disseminates real time aircraft maintenance and parts supply management information, which is information relating to the activities of the business entity, one or more customers, various maintenance service providers, a plurality of parts suppliers, and other third party separate entities that may from time to time provide parts and/or services to participants in the integration management.

The IMMSS enables the business entity to input real time aircraft maintenance and parts supply management information automatically or manually from various locations. In addition, the IMMSS permits the various internal teams within the business entity to share real time aircraft maintenance and parts supply management information when conducting negotiations and operations.

Aircraft maintenance and parts supply management information relating to the business entity, customers, maintenance and parts providers and third party participants is received by the IMMSS which stores the aircraft maintenance and parts supply management information in a database, updates the database with aircraft maintenance and parts supply management information received, tracks the aircraft maintenance and parts supply management information received, provides aircraft maintenance and parts supply management information in response to an inquiry, allows selected participants to review and comment on aircraft maintenance and parts supply management information, and provides a report to at least one managerial user within the business entity summarizing the review of aircraft maintenance and parts supply management information for the business entity.

In the IMMSS, aircraft maintenance and parts supply management information is stored in the database. The network based IMMSS provides convenient access to aircraft maintenance and parts supply management information, including at least one of business information, accounts payable, accounts receivable, availability analysis, regulatory compliance, availability projections, capital structure, parts and supply inventory, loan profile, collateral, guarantors, machinery and equipment, real estate and gate utilization, amortization, equity valuation, and other information relating to the condition of the business entity. A user must be authorized to gain access into the IMMSS.

In one embodiment, the IMMSS is a computer program embodied on a computer readable medium. In an exemplary embodiment, the system is web enabled and is run on a business-entity's intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein.

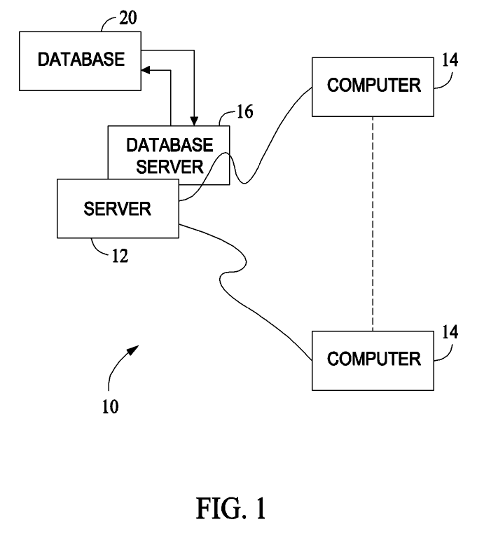

FIG. 1 is a simplified block diagram of an Integrated Maintenance and Material Supply System (IMMSS) 10 including a server system 12, and a plurality of client sub-systems, also referred to as client systems 14, connected to server system 12. In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment database 20 is stored remotely from server system 12 and may be non-centralized.

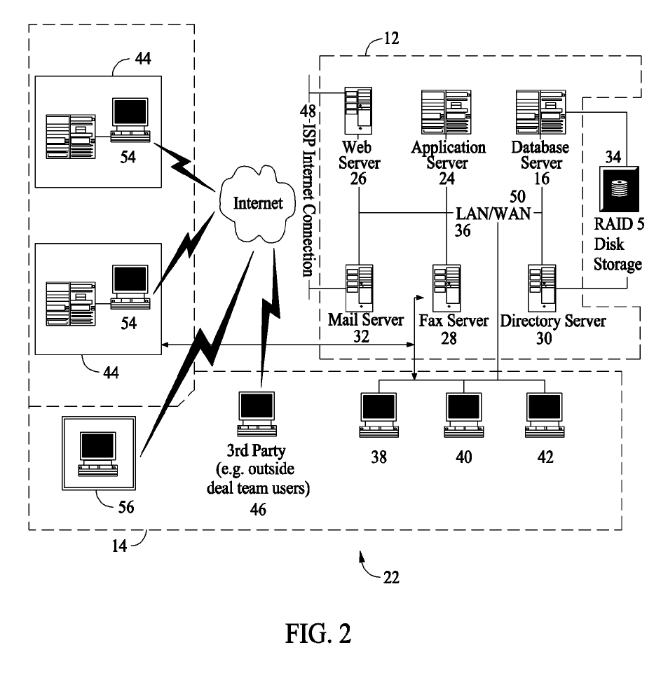

FIG. 2 is an expanded version block diagram of an exemplary embodiment of a server architecture of IMMSS 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 via an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36. In an exemplary embodiment, client system 14 includes workstation 40 which can be used by an IMMSS team user or a designated outside user to review aircraft maintenance and parts supply management information relating to a business entity.

Server system 12 is configured to be communicatively coupled to various individuals, including employees 44 and third parties, e.g., designated outside users, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than WAN 50, local area network 36 could be used in place of WAN 50.

In the exemplary embodiment, any authorized individual having a workstation 54 can access IMMSS 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 via a telephone link. Fax server 28 is configured to communicate with other client systems 38, 40, and 42 as well.

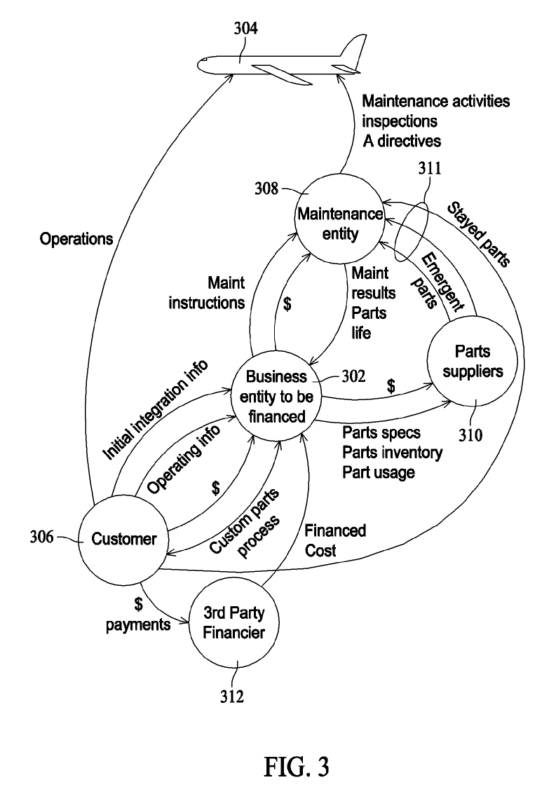

FIG. 3 is an information flow diagram of an exemplary embodiment of Integrated Maintenance and Material Supply System (IMMSS) 22 (shown in FIG. 2). IMMSS 22 includes a business entity that interacts with one or more other separate entities to perform integrated maintenance and materials supply services. In the exemplary embodiment, business entity 302 is a supplier of a business asset, such as an aircraft 304 to a customer 306. The sale of the business asset does not include the integrated maintenance and materials supply service, but rather the integrated maintenance and materials supply service is an offering that customer 306 may separately contract for during sale negotiations or afterward.

Customer 306 is typically an aircraft operator such as an airline that owns, leases, or otherwise has possession of one or more aircraft for revenue generating purposes. More typically, 306 business entity 302 and customer 306 enter into an agreement to exchange payment for integrated maintenance and materials supply services. Business entity 302 contracts with one or more maintenance entities 308 to perform maintenance activities on aircraft 304 operated by customer 306. During the course of performing the maintenance activities, maintenance entity 308 requires access to a plurality of replacement materials, parts, and component parts of aircraft 304. Business entity 302 contracts with one or more parts suppliers 310 to supply necessary replacement parts, spare parts, materials, and components to maintenance entity 308. In the exemplary embodiment, parts suppliers 310 maintain possession and customer 306 is not charged for parts until the parts are installed on one of customer 306 aircraft. Business entity 302 manages a plurality of logistical resources 311 to provide the parts proximate customer's 306 operations and maintenance entity's 308 repair and maintenance facilities. Consequently, customer 306 is not financially liable for the cost of the part until the part is installed on one of its aircraft. Such an arrangement has significant benefit for customer 306 and permits business entity 302 to use its ability to aggregate many of its activities that it already performs to provide parts logistics and part management services at lower cost than customer 306.

Business entity 302 also provides financing of such maintenance and material support activities as described herein for customer 306. Additionally, business entity 302 manages financing for the maintenance and material support activities through a third party financier 312.

Business entity 302 provides integration services to relieve customer 306 from having to maintain relationships with a plurality of maintenance and repair organizations (MRO), parts suppliers, and other third-party suppliers of maintenance and parts for customer's 306 fleet of aircraft. Business entity 302 bases a contract price on a per flight hour, per departure, per night check, or per finding basis. Business entity 302 also uses other metrics to determine a cost that is relatively predictable over the life of the contract arrangement. In the exemplary embodiment, business entity 302 is a supplier of the aircraft and as such business entity 302 possesses information regarding the life expectance of component parts of aircraft 304. Additional information such as aircraft operating data and history are obtained from customer 306. From this information, business entity 302 can determine with a relative degree of certainty, the cost of providing maintenance and parts services to customer 306.

Business entity 302 also manages the performance of maintenance aboard aircraft 304 by the MROs. Business entity 302 prepares maintenance task cards and transmits such information to maintenance entity 308. Maintenance entity 308 performs the maintenance activities in accordance with Claim the maintenance task cards and submits maintenance completion reports to IMMSS 22. Business entity 302 can then track the maintenance activities for financial planning, billing and for regulatory compliance reporting. Maintenance completion reports are also used by business entity 302 to determine future maintenance activities, part life, and failure modes and effects analysis.

Airworthiness directives (AD) are legally enforceable rules issued by the Federal Aviation Administration (FAA) that apply to aircraft, aircraft engines, propellers, and appliances. ADs specify inspections to be performed. conditions and limitations that must be complied with, and any actions that must be taken to resolve an unsafe condition. Business entity 302 monitors issuance of ADs and directs maintenance entity 308 to perform the maintenance and/or inspections required by the AD. In one embodiment, AD compliance is built into the contract price of the integrated maintenance and materials supply services such that business entity 302 and maintenance entity 308 complete the required maintenance and/or inspections without further payment by customer 306. In another alternative embodiment, compliance with ADs is managed as a contract extra that is priced per AD or as a package of compliance services for all ADs. Business entity 302 determines a price for contract AD compliance using historical data and engineering analysis of similar equipment already in the fleet.

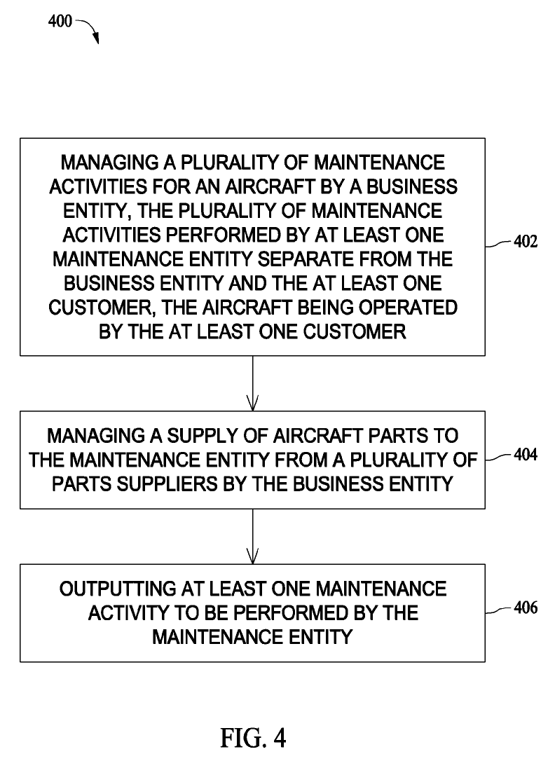

FIG. 4 is a flow diagram of a method 400 for managing aircraft maintenance and material supply by a business entity for at least one customer in accordance with an exemplary embodiment of the present invention. Method 400 includes managing 402 a plurality of maintenance activities for an aircraft by the business entity, the plurality of maintenance activities performed by at least one maintenance entity separate from the business entity and the at least one customer, the aircraft being operated by the at least one customer. Method 400 also includes managing 404 a supply of aircraft parts to the maintenance entity from a plurality of parts suppliers by the business entity.

In the exemplary embodiment, managing 402 a plurality of maintenance activities includes transmitting maintenance instructions to the maintenance entity from the business entity and receiving maintenance completion reports from the maintenance entity by the business entity, the maintenance completion reports including at least one of results of the maintenance performed, results of inspections performed, a listing of parts replaced during the maintenance activity, and a condition of the parts replaced. The maintenance entity also performs maintenance activities related to at least one of regulatory directives and airworthiness directives and the business entity pays a negotiated price for performing the maintenance activities. In the exemplary embodiment, the negotiated price is based on a historical cost of maintenance related to airworthiness directives, a failure analysis of the aircraft and components of the aircraft, or other method of predicting the cost of complying with regulatory directives with relative certainty.

In the exemplary embodiment, the maintenance entity is paid by the business entity, a negotiated price for performing the maintenance activities. The negotiated price is based on a flight departure, an overnight check, a flight hour, and an emergent work event basis.

Managing 404 the supply of aircraft parts includes determining part specifications by the business entity, inspecting parts supplied by the plurality of parts suppliers with respect to a respective one of the determined parts specifications, and staging the parts at the maintenance entity or at the plurality of parts suppliers for use by the maintenance entity for the maintenance activities.

Managing 404 the supply of aircraft parts also includes determining an inventory amount of parts to be staged at the maintenance entity or staged at the parts supplier and maintaining the determined inventory amount of parts at each of the maintenance entity and the parts supplier. A usage of the parts is monitored by the maintenance entity in performing the maintenance activities and such usage is transmitted to the business entity for evaluation of the suitability of the part specifications for the intended purpose, quality control of the supplied parts, and determining a need to modify the part specification to improve part life or part supply cost.

In some cases a customer may engage business entity to also manage a supply of non-standard parts wherein the non-standard parts are specified by the customer or another separate entity on behalf of the customer. For example, non-standard parts may include engine parts, in-flight entertainment parts, and interior and cabin parts. Customers may have components specified for their aircraft that are particular to their fleet and not supplied by the business entity. Because the business entity is already managing the maintenance and the parts supply for the customer, the customer may see a benefit to having the business entity manage maintenance and parts outside of the business entity's scope of supply.

For a new customer to the integrated maintenance and material service system, the business entity will assesses the integration of the new customer into the system. As part of the integration assessment the business entity determines a current backlog of maintenance activities that are due to be performed, including regulatory directive actions that are outstanding, determines a historical cost for maintenance activities for customer's fleet, and determines a price for managing aircraft maintenance and material supply by the business entity for the new customer.

The business entity may also license the customer for only a portion of the aircraft maintenance and material supply system. For example, a customer may license only the maintenance or the parts supply portion of the integrated maintenance and material service system and maintain management of the remaining portion or contract the remaining portion to another provider.

The above-described methods and systems for managing integrated maintenance and material services are cost-effective and highly reliable. The system collects data from maintenance entities, parts suppliers, and regulatory bodies and determines maintenance activities and parts inventory and staging for one or more customer's fleets of aircraft. The method facilitates maintenance and operations of the fleet of aircraft in a cost-effective and reliable manner.

While the invention has been described in terms of various specific embodiments, those skilled in the art will recognize that the invention can be practiced with modification within the spirit and scope of the claims.

What is claimed is:

1. A method of managing aircraft maintenance and material supply by a business entity for at least one customer comprising:
managing a plurality of maintenance activities for an aircraft by the business entity, the plurality of maintenance activities performed by at least one maintenance entity separate from the business entity and the at least one customer, the aircraft being operated by the at least one customer;
managing a supply of aircraft parts to the maintenance entity from a plurality of parts suppliers by the business entity, and
outputting at least one maintenance activity to be performed by the maintenance entity.

2. A method in accordance with claim 1 wherein managing a plurality of maintenance activities comprises:
transmitting maintenance instructions to the maintenance entity from the business entity; and
receiving maintenance completion reports from the maintenance entity by the business entity, the maintenance completion reports including at least one of results of the maintenance performed, results of inspections performed, a listing of parts replaced during the maintenance activity, and a condition of the parts replaced.

3. A method in accordance with claim 1 wherein managing a plurality of maintenance activities comprises:
performing of maintenance activities related to at least one of regulatory directives and airworthiness directives by the maintenance entity;
paying, by the business entity, a negotiated price for performing the maintenance activities, the negotiated price based on at least one of a historical cost of maintenance related to airworthiness directives and a failure analysis of the aircraft and components of the aircraft.

4. A method in accordance with claim 1 wherein managing a plurality of maintenance activities comprises paying the maintenance entity, by the business entity, a negotiated price for performing the maintenance activities, the negotiated price based on at least one of a flight departure, an overnight check, a flight hour, and an emergent work event.

5. A method in accordance with claim 1 wherein managing a supply of aircraft parts comprises:
determining part specifications by the business entity;
inspecting parts supplied by the plurality of parts suppliers with respect to a respective one of the determined parts specifications; and
staging parts at least one of at the maintenance entity and at the plurality of parts suppliers for use by the maintenance entity for the maintenance activities.

6. A method in accordance with claim 1 wherein managing a supply of aircraft parts comprises part specifications by the business entity from at least one of the maintenance entity and the customer.

7. A method in accordance with claim 1 wherein managing a supply of aircraft parts comprises:
determining an inventory amount of parts to be at least one of staged at the maintenance entity and staged at the parts supplier; and
maintaining the determined inventory amount of parts at each of the maintenance entity and the parts supplier.

8. A method in accordance with claim 1 wherein managing a supply of aircraft parts comprises managing by the business entity, logistical resources to stage the parts from the parts supplier to the maintenance entity.

9. A method in accordance with claim 1 wherein managing a supply of aircraft parts comprises maintaining ownership of the parts by the parts supplier until at least when the parts are installed in an aircraft operated by the customer.

10. A method in accordance with claim 1 wherein managing a supply of aircraft parts comprises charging the customer for the cost of the parts after the parts are installed in an aircraft operated by the customer.

11. A method in accordance with claim 1 wherein managing a supply of aircraft parts comprises monitoring a usage of parts by the maintenance entity in performing the maintenance activities.

12. A method in accordance with claim 1 wherein managing a supply of aircraft parts comprises managing a supply of non-standard parts by the business entity wherein the non-standard parts are specified by at least one of the customer and a separate entity on behalf of the customer.

13. A method in accordance with claim 12 wherein managing a supply of non-standard parts by the business entity comprises managing engine parts, in-flight entertainment parts, and interior and cabin parts.

14. A method in accordance with claim 1 wherein managing aircraft maintenance and material supply by a business entity for at least one customer further comprises assessing an integration of a new customer.

15. A method in accordance with claim 14 wherein the customer operates a fleet of at least one aircraft, said method comprises:
determining a current backlog of maintenance activities that are due to be performed;
determining a historical cost for maintenance activities for the fleet; and
determining a price for managing aircraft maintenance and material supply by the business entity for the new customer.

16. A method in accordance with claim 1 wherein the customer operates a fleet of at least one aircraft, said method comprises licensing the customer for only a portion of the aircraft maintenance and material supply by the business entity for the customer.

17. A method in accordance with claim 1 wherein managing a supply of aircraft parts comprises managing a supply of parts for a particular customer wherein the parts are not included in the managed supply of parts for that particular customer.

18. A method in accordance with claim 17 wherein managing a supply of parts for a particular customer wherein the parts are not included in the managed supply of parts for that customer comprises establishing a price for supplied parts that is less than a price established for non-customers.

19. A network-based system for managing aircraft maintenance and material supply by a business entity for at least one customer, said system comprising:
a database including data relating to aircraft maintenance, the data relating to at least one of maintenance instructions for a plurality of different types of aircraft, regulatory directives, and a plurality of aircraft parts, components, and hardware; and
a first computer system configured to be coupled to said database, said first computer system further configured to:
store data in said database;
manage a plurality of maintenance activities for an aircraft by the business entity, the plurality of maintenance activities performed by at least one maintenance entity separate from the business entity and the at least one customer, the aircraft being operated by the at least one customer; and
manage a supply of aircraft parts to the maintenance entity from a plurality of parts suppliers by the business entity.

20. A system in accordance with claim 19 wherein said first computer system is further configured to:
transmit maintenance instructions to a second computer system operated by the maintenance entity; and
receive maintenance completion reports from the maintenance entity by the business entity, the maintenance completion reports including at least one of results of the maintenance performed, results of inspections performed, a listing of parts replaced during the maintenance activity, and a condition of the parts replaced.

21. A system in accordance with claim 19 wherein said first computer system is further configured to:
transmit maintenance activities related to at least one of regulatory directives and airworthiness directives to the maintenance entity;
transmit payment from the business entity for performing the maintenance activities, the payment being for a negotiated price that is based on at least one of a historical cost of maintenance related to airworthiness directives and a failure analysis of the aircraft and components of the aircraft.

22. A system in accordance with claim 19 wherein said first computer system is further configured to transmit payment to the maintenance entity, by the business entity wherein a negotiated price for performing the maintenance activities is based on at least one of a flight departure, an overnight check, a flight hour, and an emergent work event.

23. A system in accordance with claim 19 wherein said first computer system is further configured to:
determine part specifications by the business entity;
receive inspection reports for parts supplied by the plurality of parts suppliers with respect to a respective at least one of the determined parts specifications; and
determine a staging location for parts at least one of at the maintenance entity and at the plurality of parts suppliers for use by the maintenance entity for the maintenance activities.

24. A system in accordance with claim 19 wherein said first computer system is further configured to:
determine an inventory amount of parts to be at least one of staged at the maintenance entity and staged at the parts supplier;
monitor the amount of parts at each of the maintenance entity and the parts supplier; and
transmit an alert when the amount of parts is outside a predetermined range.

25. A system in accordance with claim 19 wherein said first computer system is further configured to monitor a usage of parts by the maintenance entity in performing the maintenance activities.

26. A system in accordance with claim 19 wherein said first computer system is further configured to manage a supply of non-standard parts by the business entity wherein the non-standard parts are specified by at least one of the customer and a separate entity on behalf of the customer.

27. A system in accordance with claim 19 wherein said first computer system is further configured to manage engine parts, in-flight entertainment parts, and interior and cabin parts.

28. A system in accordance with claim 19 wherein said first computer system is further configured to assess an integration of a new customer that operates a fleet of at least one aircraft, said computer system is further configured to:
determine a current backlog of maintenance activities that are due to be performed;
determine a historical cost for maintenance activities for the fleet; and
determine a price for managing aircraft maintenance and material supply by the business entity for the new customer.

29. A system in accordance with claim 19 wherein said first computer system is further configured to determine licensing fees to be paid by the customer for only a portion of the aircraft maintenance and material supply services by the business entity for the customer.

30. A system in accordance with claim 19 wherein said first computer system is further configured to manage a supply of parts for a particular customer wherein the parts are not included in the managed supply of parts for that particular customer.

31. A system in accordance with claim 19 wherein said first computer system is further configured to facilitate determining a price for supplied parts that is less than a price established for non-customers.

32. A network-based system for managing aircraft maintenance and material supply by a business entity for at least one customer, said system comprising:
a database for storing data relating to aircraft maintenance, the data relating to at least one of maintenance instructions for a plurality of different types of aircraft, regulatory directives, and a plurality of aircraft parts, components, and hardware; and
a first computer system configured to be coupled to said database;
a second computer system communicatively coupled to said first computer system, said second computer system configured to receive maintenance reports from said maintenance entity and transmit at least a portion of the maintenance reports to the first computer system;
a third computer system communicatively coupled to said first and second computer systems, said third computer system configured to communicate parts information between said first and second computer systems;
said first computer system further configured to:
store data in said database;
manage a plurality of maintenance activities for an aircraft by the business entity, the plurality of maintenance activities performed by at least one maintenance entity separate from the business entity and the at least one customer, the aircraft being operated by the at least one customer; and
manage a supply of aircraft parts to the maintenance entity from a plurality of parts suppliers by the business entity.
